(19) United States
(12) Patent Application Publication
(10) Pub. No.: US 2006/0045699 A1
(43) Pub. Date: Mar. 2, 2006

(54) WASTE REMOVAL APPARATUS AND METHOD

(75) Inventors: David Peck, Lowville, NY (US); Jacquelyn Peck, Lowville, NY (US); William Marks, Lowville, NY (US)

Correspondence Address: BOND, SCHOENECK & KING, PLLC, ONE LINCOLN CENTER, SYRACUSE, NY, 13202-1355, US

(73) Assignee: MARKS FARMS, Lowville, NY (US)

(21) Appl. No.: 11/161,063

(22) Filed: Jul. 21, 2005

Related U.S. Application Data
(60) Provisional application No. 60/589,645, filed on Jul. 21, 2004.

(51) Int. Cl. B60P 1/64

(52) U.S. Cl. 414/500

(57) ABSTRACT

A waste removal vehicle including a loader, an elevator having a chain-driven conveyor mounted on the loader, and a pair of moveable wing arms including a flexible lower portion for engaging the surface of the location floor and forwardly mounted rollers for engaging the curb of an alley or aisle that are positioned on either side of the elevator for directing animal excrement and associated waste from a concentrated feeding location, such as a barn or stable. One end of the elevator is positioned in front of the loader to float on rollers above the floor and accept waste materials, while the opposing end communicates with the upper portion of a tank mounted on the rear of the loader. As the vehicle is driven along, the wing arms collect and direct waste to the elevator, which transports the waste to a holding tank on the back of the vehicle.

### CROSS-REFERENCE TO RELATED APPLICATION

The present application claims priority to U.S. Provisional Application No. 60/589,645, filed on Jul. 21, 2004, and entitled Waste Removal System and Method, hereby incorporated by reference.

### BACKGROUND OF THE INVENTION

1. Field of Invention

The present invention relates to waste evacuation equipment and, more specifically, to agricultural equipment for the collection, evacuation, conveyance and discharge of loose dirt, water, or other material from an excavation site, or in the handling of waste streams, such as excrements of animals kept in a stable or concentrated animal feeding operations, involving solid and liquid manure and bedding (manure slurry).

2. Description of Prior Art

The use of mechanical, or manual scraping, or pushing evacuation as a means for the removal of dirt, water, or other material from a site, or in the handling of waste streams (manure slurry) is known in the art. For example, some systems rely on modified bulldozers (e.g., loaders) that merely push waste materials out of an enclosure but do not efficiently remove water. Other systems that are presently being developed include expensive vacuum evacuation systems. Additional existing waste removal systems include expensive conveyors that are integrated into the enclosure, such as a recessed floor conveyor. These conveyors require frequent cleaning and repair.

### OBJECTS AND ADVANTAGES

It is a principal object and advantage of the present invention to provide a waste removal system for more efficiently removing waste, such as manure, from a location.

It is an additional object and advantage of the present invention to provide a waste removal system that can adapt to different sized locations.

It is a further object and advantage of the present invention to provide a waste removal system that reduces manual labor needed for cleaning operations.

It is an additional object of the present invention to provide a waste removal system that is effective over uneven surfaces.

It is a further object of the present invention to provide a waste removal system that more easily evacuates waste to a remote waste handling location.

Other objects and advantages of the present invention will in part be obvious, and in part appear hereinafter.

### SUMMARY OF THE INVENTION

In accordance with the foregoing objects and advantages, the present invention comprises a loader including a collecting tank, a forwardly mounted elevator having a chain-driven conveyor for collecting waste from the ground level and transporting it to the collecting tank, and a pair of moveable wing arms having a flexible rubber lower portion for scraping the floor and forwardly positioned rollers for engaging the curb of an alley or aisle. As the loader is driven through an enclosure or other location to be cleaned, the wing arms may be spread apart to engage the curbs and collect waste from a variety of different width aisles or alleys. Collected waste is transported up the elevator and deposited into a tank. The loader may then be driven to a central location where the waste may be dumped or ejected from the tank for further handling and/or processing.

### BRIEF DESCRIPTION OF THE DRAWINGS

The present invention will be more fully understood and appreciated by reading the following Detailed Description in conjunction with the accompanying drawings, in which:

FIG. 1 is a perspective view of the system of the present invention, with the collection assembly in the lowered position.

FIG. 2 is a perspective view of the system of the present invention, with the collection assembly in the raised position.

FIG. 3 is a front elevation view of the system of the present invention, with the collection assembly in the raised position.

FIG. 4 is a front elevation view of the system of the present invention, with the collection assembly in the lowered position.

FIG. 5 is a front elevation view of the system of the present invention, with the collection assembly in the lowered and spread positions.

FIG. 6 is a partial perspective view of the elevator system portion of the present invention.

FIG. 7 is a partial perspective view of the elevator system and a portion of the collection assembly of the present invention.

FIG. 8 is a partial perspective view of the hydraulic control system portion of the present invention.

FIG. 9 is a partial elevation front view of the elevator and tank system portion of the present invention.

FIG. 10 is a perspective view of the present invention with a hydraulically driven discharge assembly in its open position.

### DETAILED DESCRIPTION

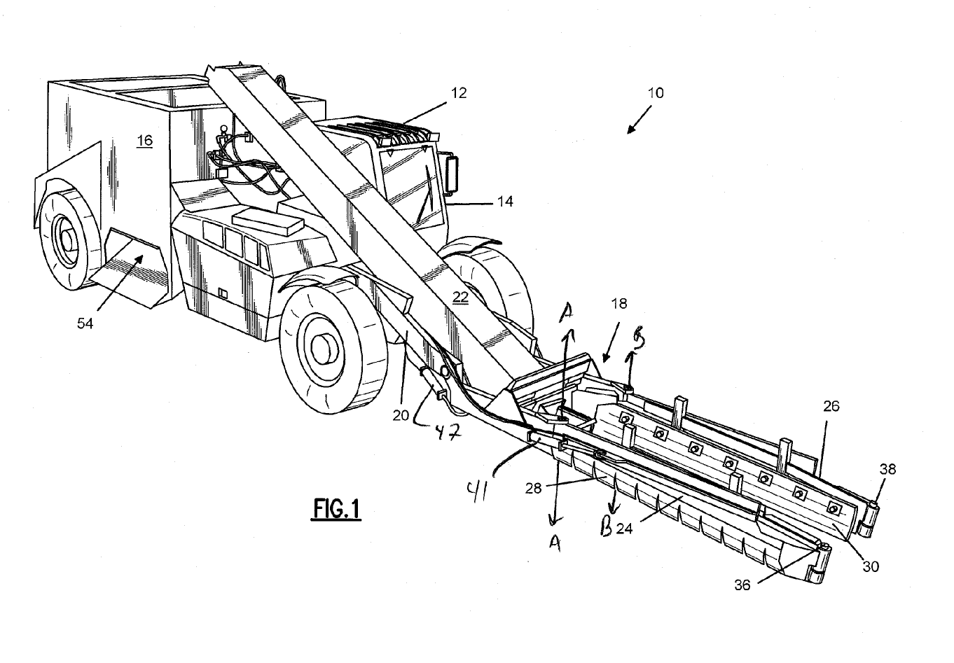

Referring now to the drawings, wherein like numeral refer to like parts throughout, there is seen in FIG. 1 a waste collection vehicle 10 useful for the removal of dirt, water, or other materials from an excavation site, or for handling waste streams (i.e., manure slurry) in a concentrated animal feeding operation, such as a stable, barn or shed. Vehicle 10 generally comprises a loader 12, such an all-wheel drive, all-wheel steering AGRI-LOADER Telescopic Loader model AL-730 available from GEHL of West Bend, Wis. Loader 12 includes a forwardly positioned operator cabin 14.

Vehicle 10 further comprises a storage tank 16 mounted to loader 12 and positioned rearwardly to cabin 14. Storage tank 16 receives waste materials to transport to a final destination. Tank 16 may be easily designed and constructed to fit on the base of any appropriate vehicle. Vehicle 10 further comprises a collection assembly 18 mounted to loader 12 and forwardly to cabin 14. Collection assembly 18 gathers waste material and transports the waste into tank 16.

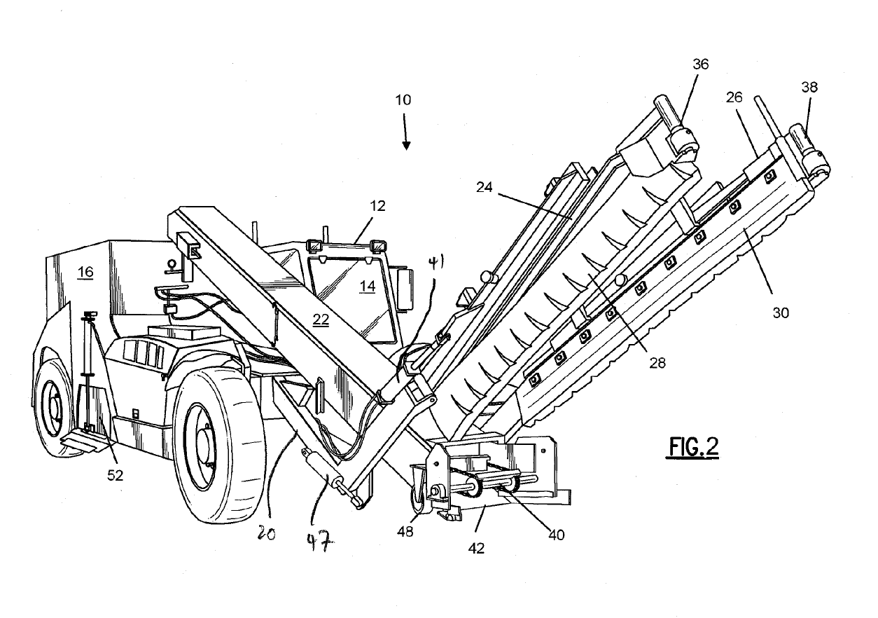

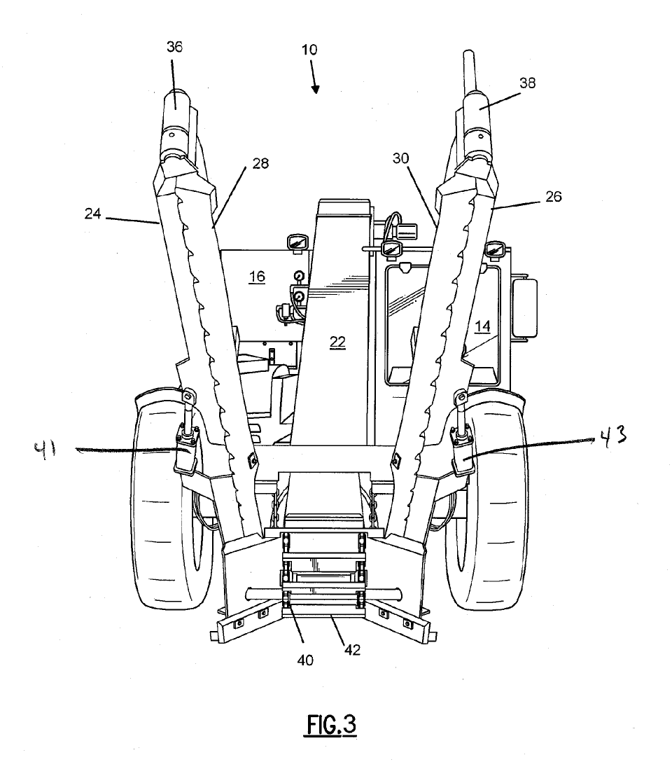

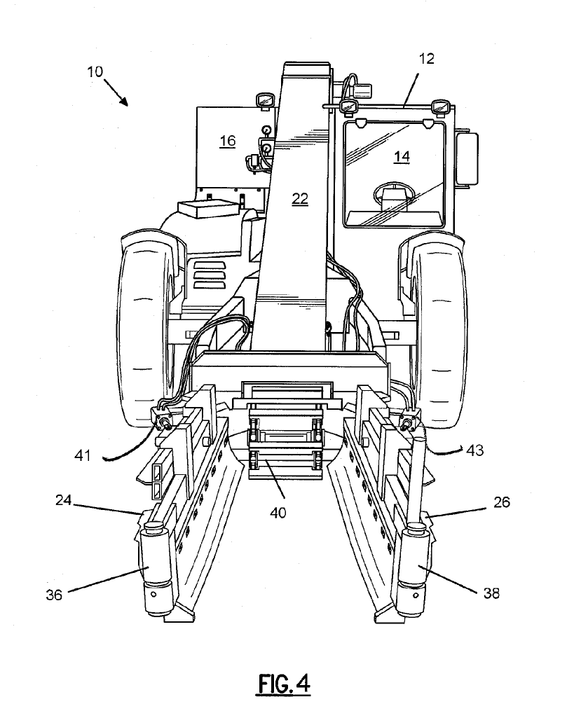

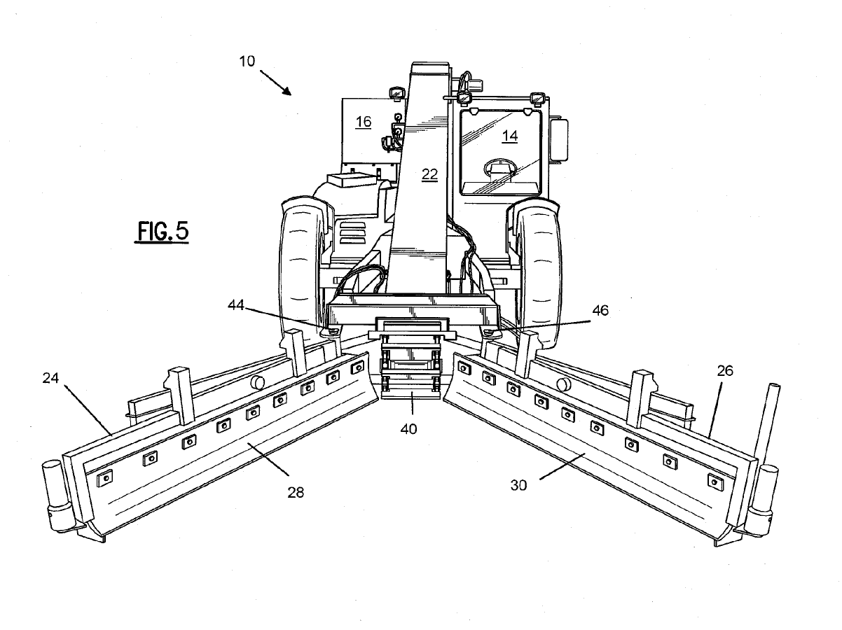

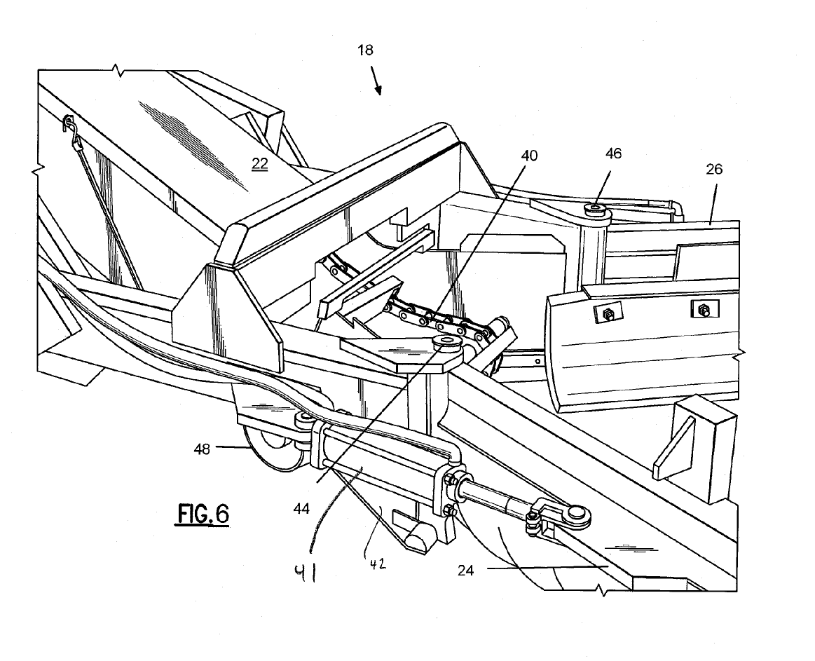

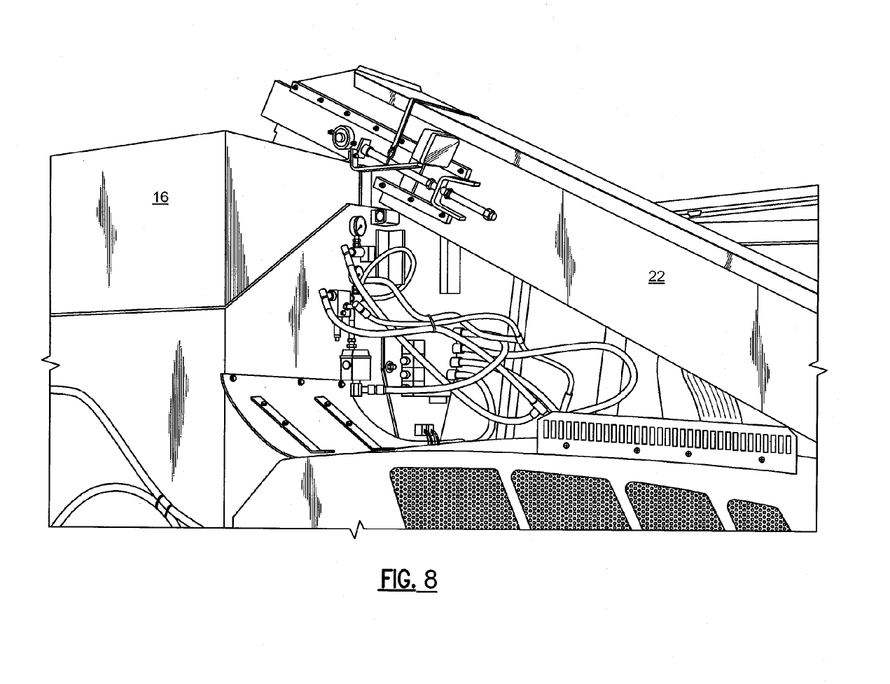

Collection assembly 18 comprises a base 20 attached to the forward side of loader 12. Base 20 supports an enclosed central elevator system 22 and a pair of forwardly presented and laterally opposed arms 24 and 26 that are attached to base 20 on opposing sides of elevator system 22. Arms 24 and 26 are each interconnected to base 20 for movement in both vertical and horizontal planes. As seen in FIGS. 2-5, arms 24 and 26 may be selectively positioned in a variety of positions to gather and direct manure or waste to the centrally mounted elevator system 22 as the loader is driven through the location to be cleaned. Arms 24 and 26 are preferably hydraulically operated for remote manipulation from the cabin 14.

The lower portion of arms 24 and 26 are provided with replaceable edges 28 and 30 securely mounted thereto, respectively, formed from rubber or a similar malleable compound that can effectively conform to and scrape the floor surface without causing significant damage to the surface of arms 24 and 26. The distal ends 32 and 34 of arms 24 and 26, respectively, further include roller assemblies 36 and 38 attached thereto which permit arms 24 and 26 to maintain contact with curbing or walls, if any, of an evacuation site while vehicle 10 journeys these along.

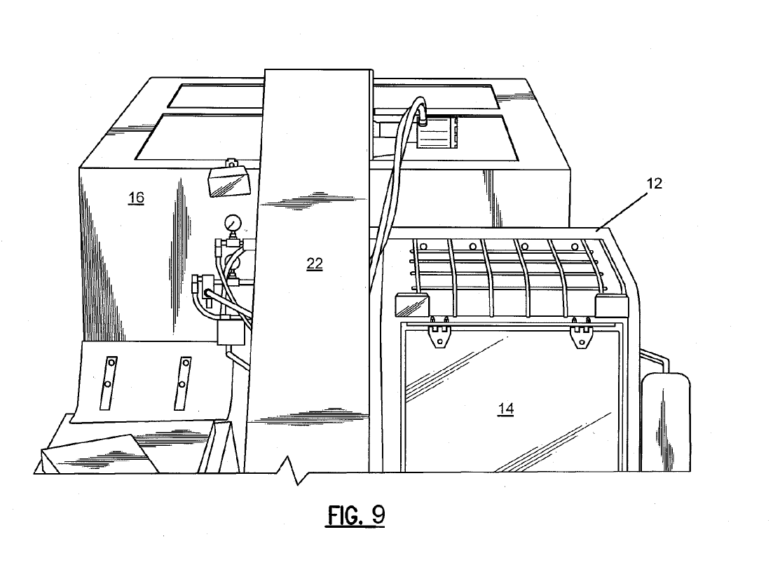

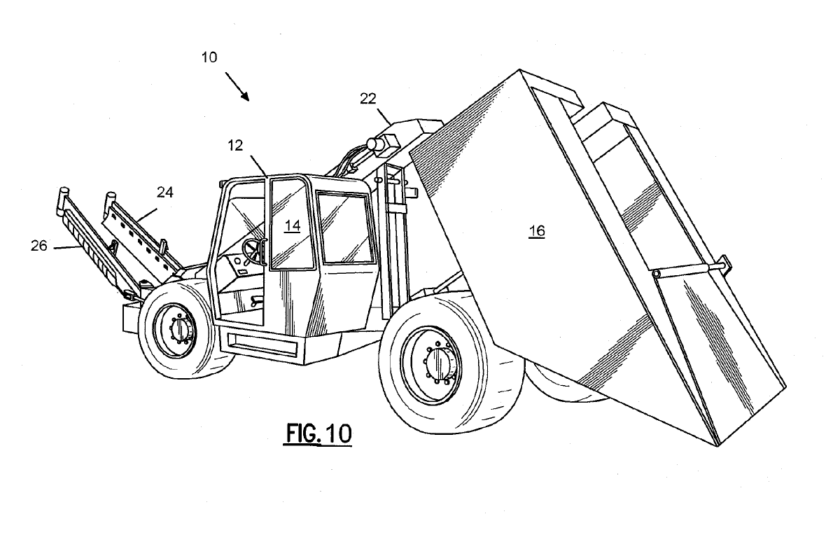

Elevator system 22 comprises a hydraulically-operated, chain-driven conveyor 40 that is positioned in vertically spaced alignment above tank 1 6 and a leading edge 42 of elevator system 22 extends forwardly relative to the proximal ends of arms 24 and 26. Conveyor 40 thus transports manure gathered by arms 24 and 26, as seen in FIG. 8. The leading edge 42 of elevator system 22 extends forwardly relative to the proximal ends of arms 24 and 26. Leading edge 42 is supported by one or more wheels 48 which suspends it above the surface to be cleaned. Wheels 48 are vertically adjustable, thereby permitting selective adjustment of the vertical distance separating edge 42 from the surface to be cleaned.

By selectively suspending leading edge 42 of elevator system 22, the system of the present invention can be attenuated to remove different types of waste materials from a site. It should be recognized by those of ordinary skill in the art that elevator system 22 may be positioned non-centrally in relation to loader 12, provided that sufficient space is available for the attachment of arms 24 and 26 on opposing sides. In addition to the three-dimensional adjustability of arms 24 and 26, the floating capability of elevator system 22 allows for continuous or adjustable contact with the floor and edging surfaces (curbing) of the evacuation site or location. Collection assembly 18 also permits appropriate cleaning of variously dimensioned evacuation sites or alleyways in a single pass.

Arms 24 and 26 are pivotally movable towards and away from one another via hydraulic piston/cylinder assemblies 41, 43, respectively. The cylinder portion of assemblies 41 and 43 are attached to base 20, while the ends of the pistons connect to arms 24 and 26. Pivot pins 44 and 46 connect arms 24 and 26 to base 20, respectively, at their proximal ends, and define pivot axes A-A and B-B, respectively, about which arms 24 and 26 move. A piston/cylinder assembly 47, the cylinder of which is mounted to the underside of base 20 with the piston being interconnected to arms 24 and 26, provides the mechanism for vertically adjusting the position of arms 24 and 26.

When arms 24 and 26 are in an outwardly extended position, the forward motion of loader 12 will force slurry in the path of arms 24 and 26 and funnel it toward the central elevator system 22. Waste material collected by arms 24 and 26 is directed to the forward portion of loader 12, where conveyor 40 of collection assembly 18 transports the waste material to tank 16. When tank 16 is full, vehicle 10 may be driven to a central waste handling location and emptied via manually or hydraulically operated door or hatch 52 to a discharge chute 54 positioned in the side or rear of tank 16. Alternatively, tank 16 may be pivotally attached to loader 12 for tilting via conventional dump truck hydraulic systems to empty collected waste rearwardly of vehicle 10.

The operating controls of loader 12 may be adapted to operate collection assembly 18, such as by providing joysticks electrically connected to the various hydraulic cylinder assemblies. Referring to FIG. 8, conventional hydraulic controls may be provided to remotely control the vertical elevation of forward end 42 of the elevator 40 from the surface of the area to be cleaned. Conventional hydraulic components may also control the opening and closing of doors 52 of tank 16.

The method of the present involves driving vehicle 10 to the location where waste is to be removed. Once positioned at the location, arms 24 and 26 are lowered so that malleable edges 28 and 30 engage the surface of the location and then arms 24 and 26 are spread to an appropriate width for the given area. For example, when collecting waste from an open area, arms 24 and 26 may be fully extended to maximize the collection of waste. In a smaller area, such as the aisle of a barn, arms 24 and 26 are spread until roller assemblies 36 and 38 engage the curbs. Once in vehicle 10 and arms 24 and 26 are in the desired position, elevator 40 is operated and vehicle 10 is driven forward. Waste is directed by arms 24 and 26 to the front of elevator 40, which transports the waste upwardly away from the surface and deposits the waste into tank 16. Once the area has been sufficiently cleaned, or tank 16 is full, vehicle 10 may be driven to a waste repository. When vehicle 10 is positioned at an appropriate discharge point, tank 16 is emptied by opening doors 52. Alternatively, vehicle may be backed up to the discharge point and tank 16 tipped so that waste is dumped from the rear of tank 16 similar to the manner in which a dump truck is emptied. Vehicle 10 may then return to the area to be cleaned and repositioned for waste removal.

what is claimed is:

1. An apparatus for use with a vehicle for removing waste from the surface of a location, comprising:
a conveyor for transporting waste from said surface;
a pair of moveable arms each having proximal and distal ends and extending outwardly from said conveyor; and
a tank for receiving and storing waste transported from said conveyor.

2. The apparatus of claim 1, further including a base for supporting said conveyor and said arms.

3. The apparatus of claim 2, wherein said arms are pivotally mounted to said base.

4. The apparatus of claim 2, wherein said arms are movable in 1st and 2nd planes.

5. The apparatus of claim 4, wherein said conveyor is mounted to said base for movement relative to said surface.

6. The apparatus of claim 5, wherein said base is mounted to the front of said vehicle.

7. The apparatus of claim 6, wherein said tank is mounted to the rear of said vehicle.

8. The apparatus of claim 7, wherein said tank is pivotally mounted to said vehicle.

9. The apparatus of claim 8, wherein said tank further includes a hatch for releasing waste collected therein.

10. The apparatus of claim 1, further comprising a roller assembly attached to said distal ends of each of said arms.

11. The apparatus of claim 1, wherein each of said arms includes a flexible edge portion for engaging said surface.

12. A vehicle for collecting and removing waste from the surface of a location, said vehicle comprising:
a frame including an operator cabin for moving in at least a forward direction;
a base attached to said frame;
a conveyor attached to said base and extending from a front end positioned forwardly of said frame to a rearward end positioned at the back of said frame, wherein said front end may be lowered into engagement with said surface or suspended thereover;
a pair of moveable arms connected to and extending forwardly from said base; and
a tank mounted to a rearward portion of said frame and positioned in alignment with the rear end of said conveyor.

13. The apparatus of claim 12, wherein said arms are pivotally mounted to said base.

14. The apparatus of claim 13, wherein said arms are moveable in both 1st and 2nd planes.

15. The apparatus of claim 14, wherein said base is mounted to the front of said frame.

16. The apparatus of claim 12, wherein said tank further includes a hatch for releasing waste collected therein.

17. A method of removing waste from the surface of a location, comprising the steps of: driving a vehicle comprising:
a frame, a frame including an operator cabin for moving in at least a forward direction;
a base attached to said frame;
a conveyor attached to said base and extending from a front end positioned forwardly of said frame to a rearward end positioned at the back of said frame;
a pair of moveable arms connected to and extending outwardly from said base; and
a tank mounted to a rearward portion of said frame and positioned in alignment with the rear end of said conveyor;
spreading said arms to a predetermined lateral distance apart;
operating said conveyor; and
driving said vehicle over the surface so that said arms capture and direct waste into said conveyor, where said waste is transported into said tank.

18. The method of claim 17, wherein said conveyor is positioned at a predetermined elevation from said surface depending on the composition of the waste to be collected.

19. The method of claim 17, further comprising the steps of driving said vehicle to a collecting location and unloading collected waste from said tank.

20. The method of claim 19, wherein the step of unloading collected waster from said tank comprising hydraulically tipping said tank relative to said vehicle so that waste is emptied.
